(19) United States
(12) Patent Application Publication
(10) Pub. No.: US 2025/0232671 A1
(43) Pub. Date: Jul. 17, 2025

(54) METHOD FOR OPERATING A VEHICLE WITH AN X-BY-WIRE DEVICE USING A FLEET WATCHDOG, AND VEHICLE

(71) Applicants: Volkswagen Aktiengesellschaft, Wolfsburg (DE); Audi AG, Ingolstadt (DE)

(72) Inventors: Arne BARTELS, Wolfsburg (DE); Frank BAERECKE, Wolfsburg (DE); Kilian FOERSTER, Beilgries (DE)

(73) Assignees: Volkswagen Aktiengesellschaft, Wolfsburg (DE); Audi AG, Ingolstadt (DE)

(21) Appl. No.: 19/170,823

(22) Filed: Apr. 4, 2025

Related U.S. Application Data
(63) Continuation of application No. PCT/EP2023/076718, filed on Sep. 27, 2023.

(30) Foreign Application Priority Data
Oct. 4, 2022 (DE) 10 2022 125 539.5

(51) Int. Cl. G08G 1/0967; G08G 1/01

(52) U.S. Cl. CPC G08G 1/096725; G08G 1/0112

(57) ABSTRACT

A method for operating a vehicle, in which at least one sensor signal is detected, which indicates an actuation of an actuation element of an X-by-wire device of the vehicle performed by a user. At least one target value associated with the sensor signal is compared to at least one actual value, which corresponds to an actual behavior of at least one component of the vehicle. Upon presence of a predetermined deviation of the actual value from the target value, at least one measure is taken. The at least one target value and the at least one actual value are transferred to a monitoring device external to the vehicle, which performs the comparison of the actual value to the target value, and which causes at least one device internal to vehicle to take the at least one measure upon presence of the deviation. Furthermore, the invention relates to a vehicle.

This nonprovisional application is a continuation of International Application No. PCT/EP2023/076718, which was filed on Sep. 27, 2023, and which claims priority to German Patent Application No. 10 2022 125 539.5, which was filed in Germany on Oct. 4, 2022, and which are both herein incorporated by reference.

### BACKGROUND OF THE INVENTION

### Field of the Invention

The invention relates to a method for operating a vehicle, in which at least one sensor signal is detected, which indicates an actuation of an actuation element of an X-by-wire device of the vehicle performed by a user of the vehicle. Herein, at least one target value associated with the sensor signal is compared to at least one actual value. The at least one actual value corresponds to an actual behavior of at least one component of the vehicle. Upon presence of a predetermined deviation of the actual value from the target value, at least one measure is taken. Furthermore, the invention relates to a vehicle formed for performing the method.

### Description of the Background Art

DE 11 2017 005 108 T5 describes a vehicle with a steer-by-wire system, in which the wheels at the front axle and at the rear axle are steered by electrical actuators. Herein, a watchdog control device is provided to detect error states at the actuators or at the steering control devices. If the watchdog control device detects an error state at the steering control device, the steering control device is deactivated or switched off. With the steering control device switched off, a warning message can be output to the driver of the vehicle or a speed of the vehicle can be slowed down.

Furthermore, DE 11 2017 004 195 T5 describes a watchdog control device for an electric vehicle, which compares an observed dynamic vehicle response to an expected range of dynamic vehicle responses. Upon a deviation exceeding a threshold value, a functionality of the electric vehicle is restricted.

In today's vehicles, mechanical brake systems and mechanical steering systems are usual. In the mechanical brake system, there is a purely mechanical coupling between a brake pedal and a mechatronic brake pressure actuator at a fallback level. This means that the driver has to apply the brake pressure without electronic amplification, thus, purely mechanically by his foot force, upon failure or malfunction of the mechanics or electronics of the brake pressure actuator. Thereby, a high brake force can still be achieved even upon a failure of the brake pressure actuator.

The same applies to the mechanical steering system. In such a mechanical steering system too, there is a purely mechanical coupling between the steering handle for instance in the form of a steering wheel and a mechatronic steering actuator at a fallback level, which is usually arranged at a front axle of the vehicle. This means that the driver has to apply the required steering forces alone with the force of his arms upon a failure or a malfunction of the mechanics or electronics of the steering actuator.

Within the scope of the development of vehicles, there are approaches to omit these mechanical fallback levels in the steering system or in the brake system. If a mechanical connection between an actuation element such as for instance a brake pedal and the brake of the vehicle is no longer present in a brake system, such a mechanically decoupled brake device is referred to as brake-by-wire brake device or brake-by-wire brake system (brake-by-wire=braking by wire).

In an analogous manner, a steering system, in which a mechanical connection between a steering handle such as for instance a steering wheel and the steering actuator is no longer present, which executes the steering command, is referred to as steer-by-wire device or steer-by-wire system (steer-by-wire=steering by wire).

Therefore, such mechanically decoupled systems or devices can be generally referred to as X-by-wire devices or X-by-wire systems. Presently, in particular a steer-by-wire device and/or a brake-by-wire device of the vehicle is to be understood by the X-by-wire device of the vehicle.

In particular in vehicles, in which a fully automatic or autonomous driving function is provided, such steer-by-wire devices and/or brake-by-wire devices can be employed. However, also in conventional vehicles, which are not designed for an autonomous driving operation, improvements with regard to the safety, the comfort and a personalization can be achieved by using the steer-by-wire device and/or the brake-by-wire device.

Due to the omission of a mechanical fallback level in by-wire steering systems and by-wire brake systems, challenges with regard to the failure safety of such X-by-wire devices arise.

For the purpose of a higher failure safety, an interface between an electronic brake pedal and a brake pressure actuator of a brake-by-wire device can for instance include a first data bus and a second, redundantly configured data bus. In analogous manner, this can be provided in an interface between an electronic steering wheel and a steering actuator of a steer-by-wire device. However, other concepts are also possible to provide a fallback level for the case of occurrence of an error in a by-wire steering system or by-wire brake system.

In particular upon occurrence of so-called common cause failures (thus errors or failures attributable to a common cause) or cascading failures (thus cascading errors or failures), it can occur that the additional fallback level is not available. For example, the case can occur that both a main path and a redundancy path fail at the same time due to a common error cause or due to a coupling mechanism.

Reasons for an occurrence of common cause failures or cascading failures can be in an installation of similar hardware components or software components in multiple control devices of the X-by-wire device. Upon presence of a certain error cause of this hardware component or software component, a failure can then occur in all affected control devices at the same time. Furthermore, error chains based on a single error cause can result in multiple control devices failing one after the other in temporally short order.

Accordingly, it is desirable if errors of an X-by-wire device of a vehicle are early determined such that measures or countermeasures optionally to be provided can be initiated in time.

### SUMMARY OF THE INVENTION

It is therefore an object of the present invention to provide a method that increases operating safety, and provides a vehicle formed for performing the method.

In an example of the method according to the invention for operating a vehicle, at least one sensor signal is detected, wherein the sensor signal indicates an actuation of an actuation element of an X-by-wire device of the vehicle performed by a user of the vehicle. At least one target value associated with the sensor signal is compared to an actual value. The at least one actual value corresponds to an actual behavior of the vehicle or at least one component of the vehicle. Upon presence of a predetermined deviation of the actual value from the target value, at least one measure is taken. In the method, the at least one target value and the at least one actual value are transferred to a monitoring device external to vehicle, which performs the comparison of the actual value to the target value. Upon presence of the deviation, the monitoring device external to vehicle causes at least one device internal to vehicle to take the at least one measure.

Advantageously, an independent control entity can be provided by the monitoring device external to vehicle, which is not also affected by the error even upon presence of an error of the X-by-wire device in the vehicle. Accordingly, providing or introducing the monitoring device external to vehicle involves increased operating safety. Because the presence of the predetermined deviation of the actual value from the target value can be determined by the monitoring device external to vehicle, which thereupon causes the at least one device internal to vehicle to take the at least one measure.

The monitoring device external to vehicle, thus separate from the vehicle and arranged outside of the vehicle, which is preferably formed for wireless communication with the vehicle, additionally allows monitoring a plurality of vehicles or a vehicle fleet with regard to possible deviations of the respective actual value from the respective target value. This is advantageous with regard to the effect that accumulations of undesired deviations can thus be early recognized. Accordingly suitable measures can be early initiated thereupon, for example measures immediately implementable in the vehicle by the device internal to vehicle and/or servicing measures or maintenance measures.

In such an application, in which a plurality of vehicles or the vehicle fleet is monitored with regard to deviations of the respective actual value from the respective target value, the monitoring device external to vehicle can be referred to as a fleet watchdog.

The corresponding advantages apply both if the at least one X-by-wire device of the vehicle is for example formed as a steer-by-wire device and if the X-by-wire device is for example formed as a brake-by-wire device. Moreover, the vehicle can comprise both the steer-by-wire device and the brake-by-wire device.

Upon formation of the X-by-wire device of the vehicle as a by-wire steering system or steer-by-wire device, the actuation element capable of being actuated by the user can be a steering handle for instance in the form of a steering wheel. Accordingly, the at least one sensor signal can for example indicate an actuation force applied to the steering wheel and/or a rotation by a respective rotational angle performed at the steering wheel. A behavior of the entire vehicle corresponding to this actuation of the steering wheel and/or a behavior at least of the component of the vehicle corresponding to the actuation of the steering wheel can be associated with such sensor signals as a target value.

The actual behavior of the entire vehicle can be described by driving-dynamic data such as for instance a yaw rate and/or a longitudinal acceleration and/or a lateral acceleration and/or a longitudinal speed and/or a lateral speed of the vehicle or the like or be detected via such data. The target values associated with the at least one sensor signal, which relate to the actual behavior of the entire vehicle, can accordingly be values of the driving-dynamic variables exemplarily mentioned above to be expected depending on the sensor signal.

The actual behavior at least of the component of the vehicle, can for instance be the behavior of a steering actuator, which is formed to effect steering of steerable wheels of the vehicle. Accordingly, a steering angle to be set by the steering actuator can for example be considered as the target value associated with the sensor signal. Because the actuation force applied to the steering wheel and/or the rotation performed at the steering wheel correspond to a target value of the steering angle, by which the steerable wheels are to be pivoted via the steering actuator.

In an analogous manner, these statements to the target values and the actual values may apply if the X-by-wire device of the vehicle is formed as a brake-by-wire device. Then, the actuation element capable of being actuated by the user of the vehicle can for instance be an electronic brake pedal, wherein the at least one sensor signal can include an actuation force applied to the electronic brake pedal and/or a distance traveled by the brake pedal.

Target values of the driving-dynamic behavior of the entire vehicle and/or target values of a brake actuator effecting braking of the vehicle or the like brake device can also be associated with such sensor signals relating to the brake-by-wire device. For example, an actuation force applied to the electronic brake pedal and/or a pedal distance in changing a position of the brake pedal can correspond to a brake pressure to be expected on the brake actuator of the brake-by-wire device as the target value. Accordingly, the actual value at least of the component of the vehicle can for instance be the actual behavior of the brake actuator, which is formed to effect the braking of the vehicle.

Such target values can be compared to such actual values, wherein the actual values correspond to the actual behavior of the vehicle or at least the component of the vehicle, it can be determined if a deviation of the actual value from the target value is present and if this deviation exceeds a predetermined or admissible deviation. If the latter is the case, the monitoring device external to vehicle can cause the at least one device internal to vehicle to take the at least one measure.

Different measures can be taken to respond to the deviation of the actual value from the target value. For example, a first measure can be in only informing the user of the vehicle that a problem with the X-by-wire device is present. Hereto, a corresponding communication device of the vehicle can be used as the device internal to vehicle, for instance in the form of a display device or a display or the like.

Furthermore, the user of the vehicle can be warned that a problem with the X-by-wire device exists. Accordingly, the information can be provided with an additional warning notice, which makes the user of the vehicle more insistently aware of the problems of the functional impairment of the X-by-wire device than a pure information. This warning or informing with emphasis can for example be implemented by flashing of a corresponding warning message and/or by an additional output of a warning sound or the like.

Additionally or alternatively, it can be recommended to the user of the vehicle to visit, for example, a workshop, or the user can be made aware of the fact that such a workshop visit is required since further drive of the vehicle will be restricted at least in near future otherwise. Such warning messages or recommendations can be output to the user by the device internal to vehicle for instance in the form of the communication device of the vehicle.

As a further measure, allowing further drive of the vehicle at a driving speed limited to a certain maximum speed and/or for a certain, limited time and/or for a certain limited driving distance comes into consideration. Herein, it can be provided that the vehicle is automatically and forcibly brought to stop after elapse of the time limit and/or after traveling the driving distance of the vehicle. This can be effected by a corresponding device of the vehicle limiting the speed and/or a device of the vehicle limiting the remaining time and/or the remaining driving distance.

As a further measure to be taken, immediately and automatically bringing the vehicle to the stop comes into consideration. Forcibly bringing the vehicle to the stop can for example be effected via a brake device of the vehicle.

The measures of increasing severity of intervention exemplarily mentioned above can in particular be taken depending on a magnitude of the deviations of the actual value from the target value. Additionally or alternatively, it is possible to take the measures of increasing severity of intervention in cascading manner, thus one after the other, in case of permanent persistence of an error or problem of the X-by-wire device.

The monitoring device external to vehicle may consider a magnitude of the deviation of the at least one actual value from the at least one target value in determining the at least one measure to be taken. For example, it can be provided that different measures are available with regard to influence on a driving state of the vehicle and/or that the at least one measure includes informing and/or warning the user of the vehicle, in particular a driver of the vehicle. In that the magnitude of the deviation of the actual value from the target value is considered in determining the measure to be taken, the severity of an error of the X-by-wire device can be correspondingly very well accounted for, in particular in well degraded manner.

The monitoring device external to vehicle may compare the respective target values and actual values of a plurality of vehicles to each other. Thus, it can be very simply determined if errors occur at the respective X-by-wire devices of the vehicles in vehicles belonging to a vehicle fleet. On the one hand, this can be used to specifically initiate the at least one measure at the affected vehicles. Additionally or alternatively, such information can be used to take measures, which help preventing occurrence of the identified errors in the future, for instance within the scope of quality management, which can in particular be located at a manufacturer of the respective vehicle. This is also advantageous with regard to an increase of the operating safety of the affected vehicle.

The monitoring device external to vehicle may consider a result of the comparison of the respective target values und actual values of the vehicle to each other in determining the at least one measure to be taken. Thereby, it can be very well and adequately responded to a presence of deviations of the target values from the actual values by the respectively affected vehicle.

The monitoring device external to vehicle may perform an evaluation based on the target values and actual values obtained from the vehicles, in which the number of deviations of the respective actual value from the respective target value is considered. This is helpful to determine flaws of the respective X-by-wire devices of the vehicles of the vehicle fleet. Because if a design range of the by-wire steering and/or of the by-wire brake system is for example exited in a greater number of vehicles of the vehicle fleet, this can be assessed as an indication that amendments at the X-by-wire device are advisable.

The number of the deviations can be considered in setting the at least one measure to be taken. Thus, it can be very well responded to a possible accumulation of errors, which finds expression in a corresponding great number of deviations.

Additionally or alternatively, the deviations can be associated with a respective error type in the evaluation, which the monitoring device external to vehicle performs based on the target values and actual values obtained from the vehicles. In this manner, certain error types can be well and simply identified such that remedy can be provided in specific manner.

The error type can be considered in determining the at least one measure to be taken. Because the measure to be taken can then be very well adapted to the respective error type. This is conducive to increasing the operating safety of the vehicle.

The monitoring device external to vehicle can perform an evaluation with respect to an occurrence of deviations in terms of time and/or in terms of location and/or related to a vehicle operation of the respective vehicle based on the target values and actual values obtained from the vehicles. The evaluation with regard to the occurrence of deviations in terms of time is advantageous to be able to determine if a wear for example caused by the time can be identified as a reason for malfunctions of the X-by-wire devices.

Moreover, the evaluation with respect to the occurrence in terms of location can indicate whether local conditions, for instance driving of the vehicle in a warmer or cooler region and/or in a rather wet or rather dry region and/or in rather flat or rather mountainous terrain or the like, and/or further environmental conditions such as for instance a state of respective roads, are possible as reasons for the occurrence of the deviations.

If it, for example, turns out that in case of unbeneficial road state, for instance due to a presence of potholes or the like, an occurrence of deviations more frequently occurs than in case of good road state, this can be used as an indication to for example to improve a vibration resistance of the X-by-wire device. Accordingly, the measure to be taken can include improving the vibration resistance.

By the evaluation with respect to the occurrence of the deviations related to the driving operation of the respective vehicle, it can, for example, be determined if for instance the driving mode of the driver and/or an operation of the X-by-wire device, for instance a high and sudden application of components of the device with electrical current or the like, results in increased stress of the X-by-wire device. Such increased stresses can be identified as a reason for the occurrence of the deviation thereupon. This is also advantageous to optionally perform a more robust design of the X-by-wire device. Accordingly, the measure to be taken can include the more robust design.

A result of the evaluation can be considered in determining the at least one measure to be taken. In particular, the measure can be in a design of the X-by-wire device considering the evaluation.

Furthermore, the occurrence of the deviations in terms of time and/or in terms of location and/or related to the vehicle operation can be advantageously taken into account in the selection of the at least one measure, which is performed by the at least one device internal to vehicle. This is advantageous.

Additionally or alternatively, the monitoring device external to vehicle can perform an evaluation with respect to accumulations of the deviations in terms of time and/or in terms of location and/or related to a vehicle operation of the respective vehicle based on the target values and actual values obtained from the vehicles. In that the frequency of the occurrence of the deviations is considered, it can for instance be decided if it is advisable to cause the at least one device internal to vehicle to take the at least one measure.

In this respect too, it is advantageous to consider a result of the evaluation in determining the at least one measure to be taken. Because if deviations occur in accumulated manner in a plurality of vehicles, this can be used as an indication of a service or maintenance of the X-by-wire device to be performed. Additionally or alternatively, it is possible and advantageous to make the type of the measure to be taken depending on the fact if the deviations occur frequently or rather rarely.

The monitoring device external to vehicle can transmit a status query to at least one control device of the X-by-wire device. Upon absence of a response to the status query after elapse of a first period of time, the monitoring device external to vehicle causes the at least one device internal to vehicle to take a first measure. Thus, it can be very timely responded if the control device of the X-by-wire device at least temporarily does not transmit a response to the status query. Furthermore, a preparation can be made in this manner to be better prepared to a further or second measure to be taken. Thus, it can in particular be achieved that the second measure can very fast take its effect. This is advantageous.

During taking the first measure, the vehicle can remain readily controllable for the user or driver thereof. Thus, it can be ensured that even upon a false trigger, thus for instance if taking the first measure in itself would not have been required at all, taking the first measure does not result in an impairment of the driving state of the vehicle undesired for the user or driver.

Additionally or alternatively, a monitoring device internal to vehicle can transmit a status query to at least one control device of the X-by-wire device, wherein the monitoring device internal to vehicle causes the at least one device internal to vehicle to take a first measure upon absence of a response to the status query after elapse of a first period of time. The monitoring device internal to vehicle can also be referred to as watchdog of the vehicle.

Such a monitoring device internal to vehicle may be operable independently of the at least one control device of the X-by-wire device, for example by providing a separate voltage supply. In addition, by design of the monitoring device internal to vehicle independent of the at least one control device of the X-by-wire device, it can be ensured that a problem occurring at the at least one control device of the X-by-wire device does not affect the monitoring device internal to vehicle at the same time. Thereby, the monitoring device internal to vehicle can very well comply with its function to monitor the X-by-wire device.

Additionally or alternatively, it can be provided that the monitoring device external to vehicle and/or the monitoring device internal to vehicle examine if the at least one control device transmits a status message to the monitoring device in predetermined time intervals, in particular in periodic manner, without a status query preceding this transmission of the status message. Accordingly, upon absence of the status message after elapse of the first period of time, the at least one device internal to vehicle can be caused to take the first measure by the monitoring device external to vehicle and/or by the monitoring device internal to vehicle. This is also advantageous to monitor the functionality of the X-by-wire device.

For example, if it is provided that the at least one control device transmits a status message to the monitoring device external to vehicle and/or to the monitoring device internal to vehicle every 50 milliseconds, thus, the device internal to vehicle can, for example, be caused to take the first measure after elapse of 60 milliseconds

Such a monitoring device internal to vehicle can also be employed in a method, in which a transfer of the at least one target value and the at least one actual value to the monitoring device external to vehicle is not provided. In such a method, instead of the monitoring device external to vehicle, the monitoring device internal to vehicle can accordingly perform the comparison of the at least one actual value to the at least one target value and, upon presence of the predetermined deviation, cause the at least one device internal to vehicle to take the at least one measure.

Therefore, the advantages and preferred configurations described for the monitoring device external to vehicle apply in analogous manner to the monitoring device internal to vehicle, in particular in a method, in which a monitoring device external to vehicle is not employed at all, but instead the monitoring device internal to vehicle. However, the monitoring device internal to vehicle can also be present in addition to the monitoring device external to vehicle.

Monitoring of the X-by-wire device of the vehicle can be performed in an at least partially automated and/or autonomous drive of the vehicle in a variant of the method. In particular in at least partially automated driving, in which a corresponding system of the vehicle autonomously takes over functions such as for instance acceleration, braking, lane change or the like, namely, the use of the X-by-wire device is advantageous. This also applies to a highly automated, in particular autonomous driving. Correspondingly, it is here advantageous if the functionality of the X-by-wire device is monitored via the monitoring device internal to vehicle and/or via the monitoring device external to vehicle.

In such a variant of the method, instead of the at least one sensor signal, which arises from the actuation of the actuation element of the X-by-wire device, a signal is detected, which for example indicates a steering requirement and/or a brake requirement, which is to be implemented by the X-by-wire device. Accordingly, a target value associated with this signal is compared to the actual value in this method, and upon presence of the deviation of the actual value from the target value, the at least one measure is taken.

Herein, the comparison of the target value to the actual value can be performed by the monitoring device external to vehicle and/or by the monitoring device internal to vehicle, which cause the at least one device internal to vehicle to take the at least one measure upon presence of the deviation.

In this manner, for instance in an automated driving operation of the vehicle, in particular in a highly automated driving operation, a failure or a malfunction of at least one component of the X-by-wire device can be determined or identified.

This is in particular advantageous if environmental conditions and/or operating conditions are present, which make a failure or a malfunction of the component or of the X-by-wire device more probable or if due to the environmental conditions, in particular due to the environmental conditions in front of the vehicle in direction of travel, a reduced performance of the X-by-wire device could result in an undesired driving situation.

The monitoring device external to vehicle and/or the monitoring device internal to vehicle can cause the at least one device internal to vehicle to take a second measure upon absence of a response to the status query after elapse of a second period of time following the first period of time.

Additionally or alternatively, the monitoring device external to vehicle and/or the monitoring device internal to vehicle can cause the at least one device internal to vehicle to take the second measure upon absence of a status message of the at least one control device after elapse of the second period of time following the first period of time. For example, the second measure can be prepared by taking the first measure, and the second measure is subsequently taken.

If the status message of the at least one control device to the monitoring device external to vehicle and/or to the monitoring device internal to vehicle is expected every 50 milliseconds, thus, a preparing first measure can for example be taken after elapse of 60 milliseconds and the second measure after elapse of 70 milliseconds.

If the second measure is braking or decelerating a drive of the vehicle, in particular within the scope of a emergency braking, thus, the first measure can include preparing or initiating the braking. For example, after elapse of a period of time of 60 milliseconds, the braking can be initiated, and the braking can be performed after elapse of a period of time of 70 milliseconds if the status message expected every 50 milliseconds is absent.

By such a graduated taking of successive measures, it can be very reliably ensured that it is timely and adequately responded to a problem or a malfunction of the X-by-wire device of the vehicle.

This can apply if the second measure more severely influences a driving state of the vehicle than the first measure. Namely, the first measure can in particular not yet or almost not influence the driving state of the vehicle, for example because only information or warning is issued to the user or the driver of the vehicle or is output to the user or driver by the device internal to vehicle as the first measure.

However, even if the first measure is for example in initiating braking of the vehicle without a deceleration of the vehicle actually already occurring, the second measure for instance in the form of an actual braking can be very fast performed. This is due to the fact that by the preparation or initiation of the actual braking operation as the first measure, the subsequent braking operation as the second measure results in a very direct and immediate deceleration of the vehicle.

If even after elapse of the second period of time, the response of the at least one control device to the status query is omitted, thus, for example braking of the vehicle, in particular braking of the vehicle until stop, can be achieved by taking the second measure. Such an emergency response is in particular advantageous to fast transfer the vehicle into a particularly safe driving state, for example in that the vehicle is brought to the stop.

The preparation of the deceleration or braking of the vehicle or the initiation of a partial braking can in particular be in that a present air space between brake pads and a brake disk of at least one wheel of the vehicle capable of being braked is reduced without any or at most a very low braking effect being already present anyway. However, by such a preparation of the braking, the subsequent braking can be very fast performed because the brake pads are already in very close proximity to the brake disk due to the preparation of the braking. This is advantageous.

If the brake device is formed as a parking brake of the vehicle, in particular as an electronic parking brake of the vehicle, which comprises a spindle drive, thus, first rotations of the spindle can be performed in the preparing braking without an actual braking effect occurring. However, the air space is already reduced due to these rotations.

In an additionally or alternatively possible configuration of the brake device of the vehicle as a hydraulic brake, the air space can be reduced by introducing brake liquid into for example a brake caliper of the brake device. According to configuration of the brake device of the vehicle, however, preparing measures different from the presently exemplarily mentioned for initiating the braking are also possible.

Upon omission of a communication with the monitoring device external to vehicle, a monitoring device internal to vehicle can perform the comparison of the actual value to the target value. Herein, the monitoring device internal to vehicle causes the at least one device internal to vehicle to take the at least one measure. Accordingly, the monitoring device internal to vehicle can in particular be used as a fallback level if the communication with the monitoring device external to vehicle is omitted.

Such a situation can, for example, occur if the communication with the external monitoring device or monitoring device external to vehicle is not possible due to a lacking or not sufficiently stable communication link. Furthermore, the communication with the monitoring device external to vehicle can be omitted if the monitoring device external to vehicle has failed or is impaired in its function for another reason. In particular in such situations, it is advantageous if it can be resorted to the monitoring device internal to vehicle, thus the watchdog of the vehicle.

The vehicle according to the invention can be configured to detect at least one sensor signal, wherein the sensor signal indicates an actuation of an actuation element of an X-by-wire device of the vehicle performed by a user of the vehicle. The vehicle is configured to associate a target value with the sensor signal and to detect at least one actual value, which corresponds to the actual behavior of at least one component of the vehicle. The vehicle can comprise a transfer device, via which the at least one target value and the at least one actual value can be transferred to a monitoring device external to vehicle. The monitoring device external to vehicle is configured to perform a comparison of the actual value to the target value and to output an instruction to a receiving device of the vehicle upon presence of a predetermined deviation of the actual value from the target value. Further, the vehicle is formed to cause at least one device internal to vehicle to take at least one measure based on the instruction.

Accordingly, the vehicle can be configured to perform the method according to the invention, wherein the vehicle involves increased operating safety.

The advantages and preferred embodiments described for the method according to the invention also apply to the vehicle according to the invention and vice versa.

Accordingly, developments of the vehicle according to the invention, which comprise features, as they have already been described in context of the developments of the method according to the invention, also belong to the invention. For this reason, the corresponding developments of the vehicle according to the invention are not again described here.

For application cases or application situations, which can arise in the method and are not explicitly described here, it can be provided that an error message and/or a request for inputting a user feedback are output and/or a default setting and/or a predetermined initial state are adjusted according to the method.

The invention also includes the combinations of the features of the described embodiments.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a simplified schematic of a vehicle, which is formed for communication with a monitoring device external to vehicle or a fleet watchdog, wherein the vehicle comprises a steer-by-wire device and a brake-by-wire device;

FIG. 2 shows schematically a plurality of vehicles according to FIG. 1, which communicate with the monitoring device external to vehicle;

FIG. 3 shows schematically a method flow, in which a monitoring device internal to vehicle or a watchdog of the vehicle is employed for monitoring the X-by-wire devices of the vehicle; and

FIG. 4 shows schematically a method flow, in which the monitoring device external to vehicle monitors the X-by-wire devices of a plurality of vehicles.

### DETAILED DESCRIPTION

The implementation examples explained in the following are preferred implementation examples of the invention. In the implementation examples, the described components each represent individual features of the invention to be considered independently of each other, which also each develop the invention independently of each other and thereby are also to be regarded as a constituent of the invention in individual manner or in a combination different from the shown one. Furthermore, the described implementation examples can also be supplemented by further ones of the already described features of the invention.

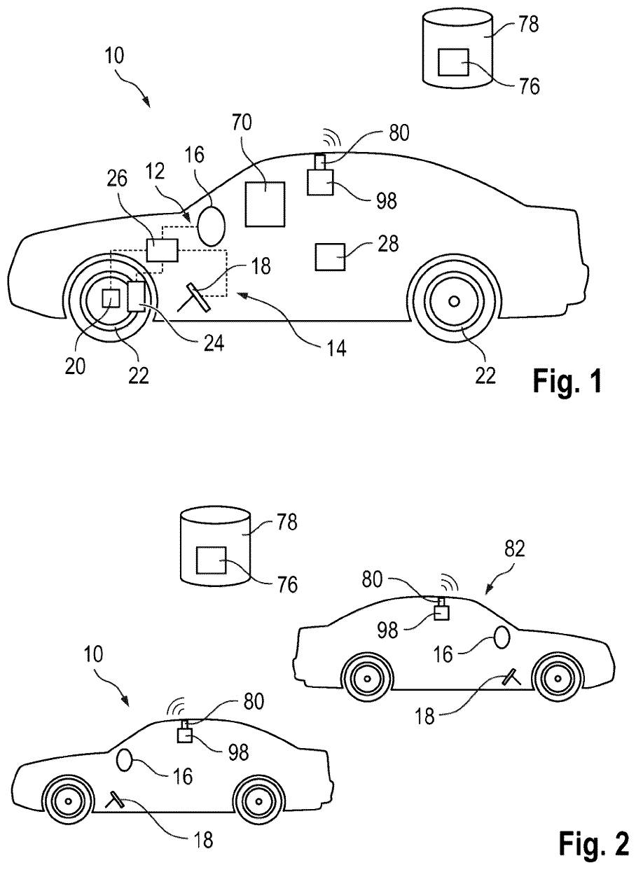

In FIG. 1, a vehicle 10, for example, formed as an automobile is shown very schematized, which comprises at least one X-by-wire device. For example, the vehicle can comprise a steer-by-wire device 12 and/or a brake-by-wire device 14 as the at least one X-by-wire device. The steer-by-wire device 12 can comprise a steering wheel 16 or a steering handle/yoke as an actuation element, at which a user of the vehicle 10, in particular the driver of the vehicle 10, can perform an actuation. In the brake-by-wire device 14, the actuation element, which can be actuated by the user or driver of the vehicle 10, can, for example, be formed as a brake pedal 18.

However, a mechanical connection from the steering wheel 16 to a steering actuator 20 of the vehicle 10 does not exist in the steer-by-wire device 12. Via the steering actuator 20, a steering angle of steerable wheels 22 of the vehicle 10 can be adjusted.

In an analogous manner, there is no mechanical connection from the brake pedal 18 to a brake device 24 or a brake actuator of the vehicle 10 in the brake-by-wire device 14. The brake device 24 is provided for braking the wheels 22 of the vehicle 10, wherein the brake device 24 is only illustrated in the area of the front wheels of the vehicle 10 for reasons of clarity.

Instead of the mechanical coupling of the steering wheel 16 to the steering actuator 20 as well as the mechanical coupling of the brake pedal 18 to the brake device 24, a control device 26 is provided in the respective X-by-wire device, which passes the driver's desire to the steering actuator 20 or to the brake device 24 electronically when the driver actuates the steering wheel 16 or the brake pedal 18. For reasons of clarity, only a single such control device 26 is illustrated in FIG. 1, although not only the respective X-by-wire device can comprise a plurality of such control devices 26. Rather, the respective X-by-wire device can comprise or include a respective control device 26, thus for example the steer-by-wire device 12 can have at least a first such control device 26 and the brake-by-wire device 14 can have at least a second such control device 26.

According to FIG. 1, the vehicle 10 comprises a control entity formed independently related to the steer-by-wire device 12 and the brake-by-wire device 14 in the form of a monitoring device 28 internal to vehicle, which can also be referred to as a vehicle watchdog. This monitoring device 28 internal to vehicle or control entity is installed within the vehicle 10 and monitors a target function and an actual function of the steer-by-wire device 12 and of the brake-by-wire device 14. If a design range of the steer-by-wire device 12 or the brake-by-wire device 14 is exited, then, a driving function of the vehicle 10 can be degraded or prevented at the instance of the vehicle watchdog.

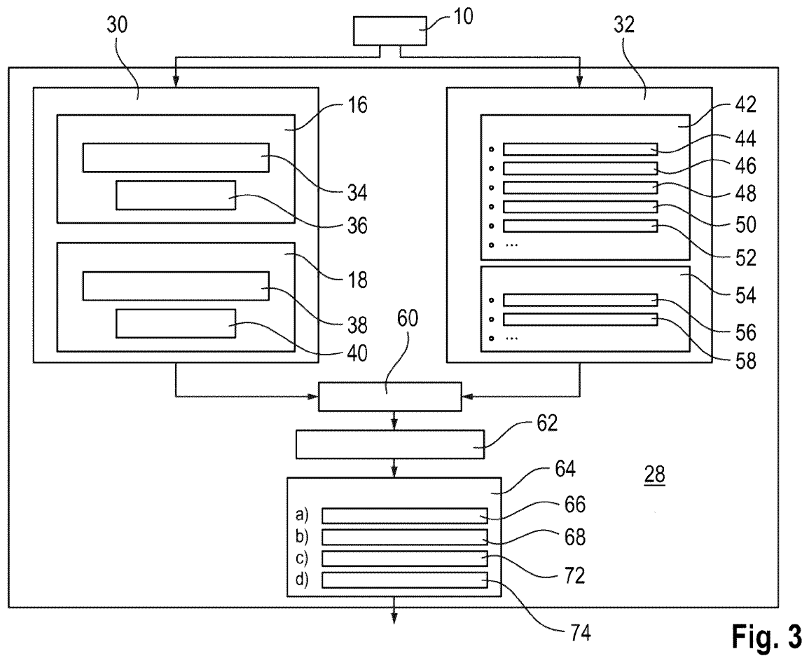

In the event of, for example, a malfunction, the driving function can be degraded and/or prevented in the event that the vehicle 10 does not comply with a driver's steering desire anymore, which the driver expresses by actuating the steering wheel 16. The same applies if the vehicle 10 does not comply with a driver's brake desire anymore, which the driver expresses by actuating the brake pedal 18. Such a departure from the design range can be ascertained based on a comparison of target values 30 or target data (see FIG. 3) to actual values 32 or actual data (see FIG. 3).

The target values 30 correspond to sensor signals of the (presently electronic) steering wheel 16 and to sensor signals of the (presently electronic) brake pedal 18. For example, a sensor of the steering wheel 16 can detect an actuation force 34 (see FIG. 3), which the driver of the vehicle 10 applies to the steering wheel 16. Additionally or alternatively, the sensor of the steering wheel 16 can detect an angle 36 (see FIG. 3), by which the steering wheel 16 is rotated by the driver from an initial position of the steering wheel 16.

The same applies to the target values 30, which describe the target behavior of the vehicle 10 with respect to the brake pedal 18. Thus, at least one sensor of the brake pedal 18 can detect an actuation force 38 (see FIG. 3), which is applied to the brake pedal 18 by the driver of the vehicle 10. Additionally or alternatively, the at least one sensor can detect a distance 40 (see FIG. 3) as the sensor signal, which the brake pedal 18 travels or by which the brake pedal 18 is pivoted when the driver of the vehicle 10 actuates the brake pedal 18.

The target values 30 (see FIG. 3) corresponding to such sensor signals can be compared to actual values 32, which correspond to the actual behavior of the vehicle 10 and/or to the behavior of at least one component of the vehicle 10, by the monitoring device 28 internal to vehicle. For example, driving-dynamic data 42 (see FIG. 3) comes into consideration as such actual values 32, for instance in the form of a yaw rate 44 of the vehicle 10 and/or a longitudinal acceleration 46 of the vehicle 10 and/or a lateral acceleration 48 of the vehicle 10 and/or a longitudinal speed 50 of the vehicle 10 and/or a lateral speed 52 of the vehicle 10. Further or other actual values 32 different from the presently exemplarily mentioned ones can also be used, which correspond to the actual behavior of the vehicle 10 as the driving-dynamic data 42.

Furthermore, sensorily detectable data of actuators 54 of the steer-by-wire device 12 or of the brake-by-wire device 14 can be used as the actual values 32 according to FIG. 3. For example, these sensorily detectable actual values 32 can be a brake pressure 56, which is applied by the brake device 24, or an axle steering angle 58, which is adjusted via the steering actuator 20.

The vehicle watchdog or the monitoring device 28 internal to vehicle can ascertain a deviation of the at least one actual value 32 from the at least one target value 30 by subtraction 60 (see FIG. 3). This deviation can be compared to a threshold value 62 to determine if a predetermined deviation is present or if the present deviation is greater than the predetermined threshold value 62.

If the comparison of the deviation to the threshold value 62 yields that the predetermined deviation of the at least one actual value 32 from the at least one target value 30 is present, thus, at least one measure to be taken can be selected from a measure block 64 according to FIG. 3. For example, the at least one measure can include informing 66 the driver of the vehicle 10 or warning 68 the driver of the vehicle 10. For informing 66 and/or warning 68, a device 70 internal to vehicle (see FIG. 1) can be used, which can for example be formed as a display device or display of the vehicle 10.

A further measure can be formed as limitation 72 (see FIG. 3) of a further drive of the vehicle 10. For example, a limitation 72 of a further driving of the vehicle 10 can be in that only a further driving of the vehicle 10 with reduced speed is allowed, for example upon driving the vehicle 10 on a highway with a speed of not more than 130 km/h. Additionally or alternatively, the limitation 72 can be in that the vehicle can be driven only for a certain limited time of for example 40 minutes and/or only on a limited driving distance, for example on a driving distance of 25 kilometers. Herein, the vehicle 10 can be automatically and forcibly brought to the stop after elapse of this time limit and/or distance limit.

Also this limitation 72 of the driving speed of the vehicle 10 and/or the limitation 72 of the driving time and/or the driving distance can be performed by the at least one device 70 internal to vehicle of the vehicle 10, which is illustrated in FIG. 1 only severely schematized for this reason.

A further measure to be taken can include an immediate stop 74 (see FIG. 3) of the vehicle 10. Accordingly, the vehicle 10 is immediately automatically and forcibly brought to the stop. The measure of stopping 74 can also be effected by the device 70 internal to vehicle, for instance in that the device 70 ensures actuation of the brake device 24.

In particular in taking the measures in the form of the informing 66, the warning 68 or the limiting 72, a workshop visit can be recommended to the driver of the vehicle 10 or such a workshop visit can be requested from him.

Whether the informing 66, the warning 68, the limiting 72 or the stopping 74 is selected as the measure, can be made dependent on the specific error pattern in the vehicle 10. This error pattern can for example be described by a magnitude of the deviation of the target values 30 and the actual values 32 from each other. In case of a greater deviation of the at least one actual value 32 from the at least one target value 30, a measure more severely influencing the driving state of the vehicle 10 can in particular be selected, for instance the limiting 72 or even the stopping 74. In contrast, in case of a lower magnitude of the deviation of the at least one actual value 32 from the at least one target value 30, the informing 66 or the warning 68 can be sufficient.

Additionally or alternatively, it is possible to take the measures exemplarily mentioned above in a cascading manner, thus for instance first informing 66, then warning 68, then limiting 72 and finally stopping 74, wherein not all of these exemplarily mentioned measures have to be actually provided. In order to take measures in a cascading manner, it is rather principally sufficient to first perform a first measure and then a second measure.

In the situation shown in FIG. 1, a monitoring device 76, (i.e. a vehicle monitor) external to vehicle is present, which is an external control entity, which is located outside of the vehicle 10. This monitoring device 76 external to vehicle can for example be located on a server 78, which is illustrated severely schematized in FIG. 1. The vehicle 10 is adapted to communicate with the monitoring device 76 external to vehicle. Hereto, the vehicle 10 comprises a transfer device 80, via which the target values 30 and the actual values 32 can be transferred to the monitoring device 76 external to vehicle.

According to FIG. 2, such a transfer to the monitoring device 76 external to vehicle can also be performed by a plurality of vehicles 10, 82, wherein only one further vehicle 82 is illustrated in FIG. 2 in addition to the vehicle 10 according to FIG. 1. Herein, the at least one further vehicle 82 can be correspondingly or similarly constructed to the vehicle 10 described with reference to FIG. 1 with regard to the functionalities. Presently, the further vehicle 82 exemplarily shown in FIG. 2 at least also comprises the transfer device 80 as well as the at least one X-by-wire device. Therefore, the (electronic) steering wheel 16 as well as the (electronic) brake pedal 18 of the associated X-by-wire device are exemplarily schematically shown in the further vehicle 82 in FIG. 2.

Since the respective target values 30 and actual values 32 of a plurality of vehicles 10, 82 can be transferred to the monitoring device 76 external to vehicle, the monitoring device 76 external to vehicle can also be referred to as a fleet watchdog.

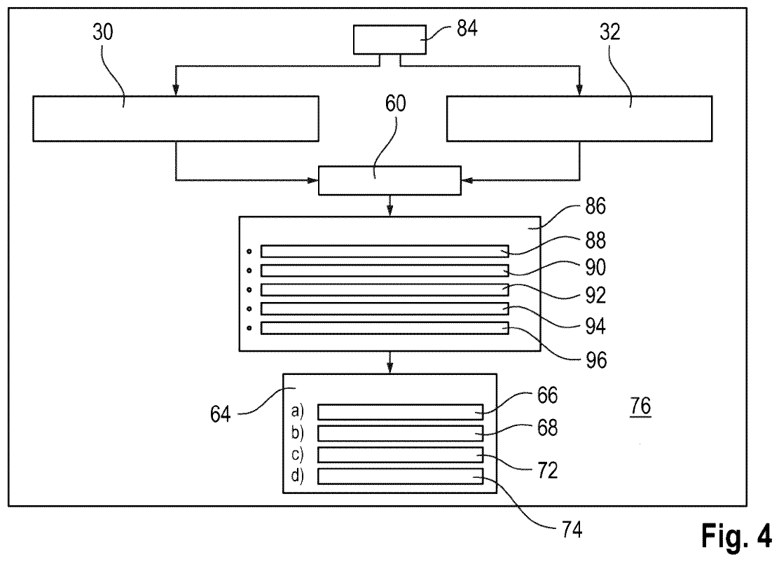

According to FIG. 4, upon employment or use of the monitoring device 76 external to vehicle, the target values 30 and the actual values 32 can be ascertained as it was explained with reference to FIG. 1 and FIG. 3 for the vehicle watchdog and the monitoring device 28 internal to vehicle, respectively. These target values 30 and actual values 32 can be referred to as vehicle fleet data 84 (see FIG. 4) in using the fleet watchdog.

According to FIG. 2, errors for instance of the steer-by-wire device 12 of the respective vehicle 10, 82 and/or of the brake-by-wire device 14 of the respective vehicle 10, 82 can be reported to the monitoring device 76 external to vehicle.

As described for the functionality of the vehicle watchdog, in using the monitoring device 76 external to vehicle, the measures from a corresponding measure block 64 shown in FIG. 4 can be applied, as they have already been explained with reference to FIG. 1 and FIG. 3. Accordingly, the monitoring device 76 external to vehicle can cause the at least one device 70 internal to vehicle (not shown in FIG. 2) of the respective vehicle 10, 82 to take at least one measure if a deviation of the actual value 32 from the target value 30 is present. Herein too, the subtraction 60 can be performed, wherein this subtraction 60 is performed by the monitoring device 76 external to vehicle according to FIG. 4.

The measure block 64 according to FIG. 4 preferably includes the measures of informing 66, of warning 68, of limiting 72 and of stopping 74 as they have already been explained with reference to FIG. 3. At least one of these measures can in particular be taken if a design range of the respective steer-by-wire device 12 and/or brake-by-wire device 14 is exited in a corresponding number of vehicles 10, 82 or fleet vehicles. Additionally or alternatively, at least one of these measures can be taken if certain errors in the steer-by-wire device 12 and/or the brake-by-wire device 14 of the respective vehicle 10, 82 accumulate.

If the monitoring device 76 external to vehicle or the fleet watchdog is employed, taking the respective measure cannot only be determined for each individual vehicle 10, 82, in that a threshold value comparison 86 is performed (see FIG. 4), in contrast to the explanations made with reference to FIG. 1 and FIG. 3. Rather, an evaluation of the vehicle fleet data 84 advantageously offers the additional possibility of ascertaining error patterns in the entire vehicle fleet.

Such error patterns can for example include an accumulation or frequency 88 of certain errors or anomalies of the X-by-wire devices of the vehicles 10, 82. Additionally or alternatively, a severity 90 of the respective error can be ascertained by evaluation of the vehicle fleet data 84 via the monitoring device 76 external to vehicle. For example, the severity 90 of the respective error can be detected in that a magnitude of the deviation of the respective actual value 32 from the respective target value 30 is determined.

Additionally or alternatively, it can be determined that certain errors occur in accumulated manner with respect to a time 92 or occur at all. An evaluation with respect to the temporal occurrence and/or the temporal accumulation of deviations is also advantageous to be able to take corresponding measures.

Additionally or alternatively, an evaluation with respect to a location 94 of the occurrence and/or the location 94 of the accumulation of certain errors can be performed by the monitoring device 76 external to vehicle. Because an evaluation of the vehicle fleet data 84 with regard to the local occurrence and/or the local accumulation is very informative for taking possible measures, in particular in the form of a service and/or maintenance of the respective X-by-wire device of the respective vehicle 10, 82.

Additionally or alternatively, the evaluation can be performed with respect to an occurrence and/or an accumulation of deviations related to a vehicle operation 96 (see FIG. 4) of the respective vehicle 10, 82. Such an analysis of the operation-related occurrence and/or the operation-related accumulation of certain errors is also beneficial to initiate corresponding measures or countermeasures.

In this way, it can for example be recognized if errors occur or occur in accumulated manner in the steer-by-wire device 12 and/or the brake-by-wire device 14 in certain environmental conditions and/or operating conditions of the respective vehicle 10, 82. Then, corresponding provisions can be made with respect to such environmental conditions and/or operating conditions. Such measures can for instance include a more robust design of the respective X-by-wire device. In particular, a quality management of a respective manufacturer of the respective vehicle 10, 82 can be informed in order that suitable measures can be initiated in this way.

In the approach described with reference to FIG. 4 too, cascading of the measures for instance in the form of the informing 66, the warning 68, the limiting 72 and the stopping 74 can be provided. Which one of these measures is taken, can be made dependent on the specific error pattern, which has been identified by the monitoring device 76 external to vehicle in the vehicle fleet. Herein, the error pattern can be determined by the frequency 88 and/or the severity 90 and/or the time 92 and/or the location 94 of the occurrence or accumulated occurrence as explained above.

The at least one vehicle 10, 82 presently comprises a respective receiving device 98, which is formed to receive an instruction from the monitoring device 76 external to vehicle. Based on this instruction, the at least one device 70 internal to vehicle of the respective vehicle 10, 82 can then take the at least one measure.

Both if the monitoring device 76 external to vehicle is present and if the monitoring device 28 internal to vehicle is present instead or in addition, it can be proceeded as exemplarily explained below.

First, the watchdog or the monitoring device 28 internal to vehicle and/or the fleet watchdog or the monitoring device 76 external to vehicle monitor the functionality of the at least one X-by-wire device of the vehicle 10, 82.

For this purpose, the monitoring device 28, 76 can for example transmit a status query to the at least one control device 26 of the X-by-wire device. If the X-by-wire device does not transmit a response after elapse of a first period of time, the monitoring device 28, 76 can take a first measure.

For example, braking of the vehicle 10, 82 can be prepared or initiated. Additionally or alternatively, it is possible to inform or warn the driver of the vehicle 10, 82 as the first measure. If the response to the status query is absent after elapse of the first period of time, there are two possibilities.

Namely, if a response to the status query arrives at the monitoring device 28, 76 after elapse of the first period of time, but before elapse of a second period of time, which follows the first period of time, thus, it can be inferred that a failure of the X-by-wire device is not present. Thereupon, the first action in the form of the first measure can be aborted.

Herein, it is advantageous if the first measure is with regard to the severity of intervention or an influence on the driving state of the vehicle 10, 82 such that neither the measure or action itself nor abortion of the measure or action aggravates a controllability of the vehicle 10, 82 by the driver. Thus, it is ensured that even upon false initiation in the form of the taking the first measure not required per se, a driving situation of the vehicle 10, 82 possibly only difficultly controllable by the driver does not occur.

However, if the at least one control device 26 of the respective X-by-wire device of the vehicle 10, 82 does not transmit a response to the status query even after elapse of the second period of time, this can be assessed by the monitoring device 28, 76 as an indication that the X-by-wire device of the vehicle 10, 82 is not functional or defective.

Thereupon, the device 70 internal to vehicle of the vehicle 10, 82 can be caused to take a second measure. In particular, this is advantageous if the second measure more severely influences the driving state of the vehicle 10, 82 than the first measure. For example, after elapse of the second period of time, the complete stop 74 of the vehicle 10, 82 can be effected as an emergency response or second measure.

If the first measure is in initiating or preparing a braking of the vehicle 10, 82, thus, the complete stop 74 can be formed as reinforcing a brake effect of the brake device 24. This in particular applies if the preparation of the deceleration of the vehicle 10, 82 only results in an extremely weak deceleration of the drive of the vehicle 10, 82 not noticeable for the driver of the vehicle 10, 82.

In such a preparation of the deceleration of the vehicle 10, 82, it can be ensured that brake pads of the brake device 24 just contact a brake disk of the brake device 24 without a noticeable pressure being exerted on the brake disk by the brake pads. However, by such a reduction of an air space between brake pads and brake disk, it can be achieved that the subsequent stop 74 particularly fast proceeds. Accordingly a particularly safe state of the vehicle 10, 82 can in particular be established via such an emergency response in the form of the fast stop 74 of the vehicle 10, 82.

Presently, a two-stage taking of the measures has been exemplarily described, thus taking the first measure after elapse of the first period of time and absence of the response to the status query, and taking the second measure after elapse of the second period of time and persistent absence of a response to the status query. However, it is also possible to provide more than two stages in taking respective measures, wherein it is correspondingly examined if a response to the status query still has not arrived at the monitoring device 28, 76 after elapse of a plurality of periods of time.

Related to the exemplarily mentioned case of initiating a braking, after unsuccessful elapse of the first period of time, the component of the brake device 24 to be supplied with brake liquid can for example be pre-filled. After elapse of the second period of time, a pressure of the brake liquid or the like hydraulic liquid can be increased. Furthermore, after elapse of a third period of time, the pressure can be still further increased. Finally, after elapse of a fourth period of time and further persisting absence of a response to the status query, a complete braking or deceleration of the vehicle 10 can be effected by the brake device 24.

The monitoring device 28, 76, can provide for all of these cascading interventions in the form of the pre-filling, the increasing the pressure and finally the braking, in that a corresponding instruction is respectively output to the at least one device 70 internal to vehicle.

The above mentioned taking of measures based on each other after elapse of four periods of time in total is to be only exemplarily understood with regard to the number of the periods of time and the configuration of the measures. Accordingly, less measures or more measures can also be taken based on each other after unsuccessful elapse of a respective period of time.

Overall, the examples show how an improved watchdog for by-wire steering systems and/or by-wire brake systems can be provided.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a vehicle, the method comprising:
detecting at least one sensor signal that indicates an actuation of an actuator of an X-by-wire device of the vehicle performed by a user of the vehicle;
comparing at least one target value associated with the sensor signal to at least one actual value, which corresponds to an actual behavior of at least one component of the vehicle;
performing at least one measure upon a presence of a predetermined deviation of the actual value from the target value;
transferring the at least one target value and the at least one actual value to a vehicle monitor that is external to the vehicle, the vehicle monitor performing a comparison of the actual value to the target value in order to determine a deviation; and
providing to an at least one internal vehicle device, the at least one measure upon presence of the deviation.

2. The method according to claim 1, wherein the vehicle monitor external to the vehicle considers a magnitude of the deviation of the at least one actual value from the at least one target value in determining the at least one measure to be taken.

3. The method according to claim 1, wherein the vehicle monitor external to the vehicle compares the respective target values and actual values of at least two vehicles to each other, and wherein the vehicle monitor external to the vehicle considers a result of the comparison in determining the at least one measure to be taken.

4. The method according to claim 3, wherein the vehicle monitor external to the vehicle performs an evaluation based on the target values and actual values obtained from the vehicles, in which a number of deviations of the respective actual value from the respective target value is considered, and/or the deviations are associated with a respective error type, and wherein a number of the deviations and/or an error type are considered in determining the at least one measure to be taken.

5. The method according to claim 3, wherein the vehicle monitor external to the vehicle performs an evaluation based on the target values and actual values obtained from the vehicles with respect to an occurrence of deviations in terms of time and/or in terms of location and/or related to a vehicle operation of the respective vehicle, and wherein a result of the evaluation is considered in determining the at least one measure to be taken.

6. The method according to claim 3, wherein the vehicle monitor external to the vehicle performs an evaluation based on the target values and actual values obtained from the vehicles with respect to an accumulation of deviations in terms of time and/or in terms of location or related to a vehicle operation of the respective vehicle, and wherein a result of the evaluation is considered in determining the at least one measure to be taken.

7. The method according to claim 1, wherein the vehicle monitor external to the vehicle and/or a vehicle internal monitor that is internal to the vehicle transmits a status query to at least one controller of the X-by-wire device and causes the at least one internal vehicle device to vehicle to take a first measure upon absence of a response to the status query after elapse of a first period of time.

8. The method according to claim 7, wherein the vehicle monitor external to the vehicle and/or the vehicle internal monitor cause, upon absence of a response to the status query after elapse of a second period of time following the first period of time, the at least one internal vehicle device to take a second measure, in particular more severely influencing a driving state of the vehicle than the first measure.

9. The method according to claim 1, wherein, upon omission of a communication with the vehicle monitor external to the vehicle, a vehicle internal monitor that is internal to vehicle performs the comparison of the actual value to the target value and causes the at least one internal vehicle device to take the at least one measure.

10. A vehicle, which is adapted to detect at least one sensor signal, which indicates an actuation of an actuation element of an X-by-wire device of the vehicle performed by a user of the vehicle, wherein the vehicle is adapted to associate a target value with the sensor signal and detects at least one actual value, which corresponds to an actual behavior of at least one component of the vehicle, the vehicle comprising:
a transmitter, via which the at least one target value and the at least one actual value are transferred to a vehicle monitor that is external to the vehicle, to perform a comparison of the actual value to the target value and to output an instruction to a receiver of the vehicle upon presence of a predetermined deviation of the actual value from the target value,
wherein the vehicle causes at least one internal vehicle device of the vehicle to take at least one measure based on the instruction.
